(19) United States
(12) Patent Application Publication
(10) Pub. No.: US 2019/0084551 A1
(43) Pub. Date: Mar. 21, 2019

(54) METHOD OF CONTROLLING THE OPERATION OF A RANGE EXTENDED PLUG-IN HYBRID ELECTRIC VEHICLE

(71) Applicant: Ford Global Technologies, LLC, Dearborn, MI (US)

(72) Inventors: Peter Brittle, Romford (GB); James Foster, Worthing (GB); Toby-Jon Wilkinson, London (GB); Owen Styles, Basildon (GB)

(21) Appl. No.: 16/027,138

(22) Filed: Jul. 3, 2018

(30) Foreign Application Priority Data
Sep. 19, 2017 (GB) 1715029.3

(51) Int. Cl. B60W 10/06; B60W 10/08; B60W 10/26; B60W 30/188; B60W 20/12; B60L 11/18; B60K 6/445; H02J 7/02

(52) U.S. Cl. CPC B60W 10/06; B60W 10/08; B60W 10/26; B60W 30/1888; H02J 7/02; B60L 11/1816; B60L 11/1861; B60K 6/445; B60W 20/12

(57) ABSTRACT

A method for operating a hybrid electric vehicle including determining a period of time and a speed of crankshaft rotation inducing lubricant delivery to a lubricated component in an internal combustion engine of a vehicle based on an ambient temperature and when a period of combustion inactivity exceeds a threshold and a state of charge of an electrical storage device is above a limit and attached to an external power source, rotating the crankshaft for the duration and speed using an electric machine.

### CROSS REFERENCE TO RELATED APPLICATIONS

The present application claims priority to Great Britain Patent Application No. 1715029.3, entitled “A METHOD OF CONTROLLING THE OPERATION OF A RANGE EXTENDED PLUG-IN HYBRID ELECTRIC VEHICLE” and filed on Sep. 19, 2017. The entire contents of the above-listed application are hereby incorporated by reference for all purposes.

### FIELD

The present description relates generally to a motor vehicle and in particular to a method of controlling a hybrid electric vehicle.

### BACKGROUND/SUMMARY

Range extended Plug-in Hybrid Electric Vehicles (PHEVs) normally have a high voltage electric generator that is coupled to a conventional reciprocating piston internal combustion engine. The PHEV is configured to have an on-board high voltage battery charged by connecting it to an electrical power grid when the PHEV is parked. The electrical energy stored in the high voltage battery is then used to power a high voltage electric traction motor to drive one or more wheels of the PHEV.

When the state of charge of the high voltage battery drops below a predefined level, the motor-generator is used to crank the engine or a separate starter motor is used to crank the engine to start it and when it is running, torque from the engine is used by the high voltage generator to generate electrical energy that enables the PHEV to continue traveling even though the high voltage battery is almost exhausted.

One problem associated with such vehicles, is that if the PHEV is used for mainly short trips where only electric power is required to propel the PHEV then the combustion engine may not be run for many days or weeks if the user only uses the electric power that is supplied by the grid or from recuperation events.

During such long periods of non-use the oil used to lubricate various parts of the engine can drain out and a corrosive reaction will begin in addition because the vehicle is still in use road induced vibration can accelerate the oil draining process and micro wear due to the transmission of vibrations to the engine.

When the engine is eventually started after a long period of such non-use wear of oil lubricated mating surfaces of the engine will be accelerated due to the lack of oil between the mating surfaces and the presence of the products of corrosion produced during the non-use period.

To overcome (e.g., minimize) at least some of the aforementioned problems a method of controlling the operation of a range extended plug-in hybrid electric vehicle is provided.

Specifically, in one aspect, the method controls the operation of a range extended plug-in hybrid electric vehicle having a combustion engine driving an engine lubrication oil pump, an electrical machine driveably connected to a crankshaft of the combustion engine, a high voltage electrical storage device to store electrical energy and a high voltage electric traction motor electrically connected to the high voltage storage device and arranged to selectively drive the electric vehicle is provided. The method includes the steps of measuring a length of time during which the combustion engine has not been run and, when the length of time exceeds a predefined time threshold and a state of charge of the high voltage electrical storage device is above a predefined limit and the vehicle is connected to an external mains supply of electricity and the vehicle is stationary, using the electrical machine to rotate the crankshaft of the combustion engine so as to supply oil from the oil pump to components of the combustion engine. When the combustion engine is rotated for a period of time and at a rotational speed sufficient to supply lubrication oil to oil lubricated components of the combustion engine, the period of time for which the engine is to be rotated and the rotational speed of the engine when it is rotated are both calculated based upon ambient temperature. When taking into account ambient temperature, the crankshaft rotation process that induces engine lubrication is made more efficient. Furthermore, the method allows the engine components to be lubricated during extended periods of combustion inactivity without interfering with hybrid vehicle charging operation.

In one example, the electrical machine may be a motor-generator driveably connected to the crankshaft of the combustion engine and rotating the crankshaft of the combustion engine may comprise using the motor-generator to rotate the crankshaft of the combustion engine.

In another example, electrical energy from the high voltage storage device may be used to power the motor-generator. Alternatively, in another example, electrical energy from an external mains supply of electricity may be used to power the motor-generator.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 is a flow chart of a method of controlling the operation of a range extended plug-in hybrid electric vehicle (PHEV) in accordance with a first aspect.

FIG. 2 is a schematic diagram of a PHEV in accordance with a second aspect.

FIG. 3 is a schematic diagram showing the connection of an internal combustion engine of the PHEV to a high voltage electrical machine of the PHEV via a coupling.

FIG. 4 is another method for controlling operation of a hybrid vehicle.

FIG. 5 shows an example control diagram for a hybrid vehicle.

### DETAILED DESCRIPTION

A motor vehicle (e.g., range extended plug-in hybrid electric vehicle) and method for controlling the vehicle having an internal combustion engine drivingly connected to a motor-generator (e.g., high voltage electric power generator) is described herein. The method allows a crankshaft of the internal combustion engine to be rotated during periods of engine inactivity only when selected entry conditions are achieved to prevent the method from interfering with other vehicle operations, such as charging operation. The crankshaft rotation may induce pumping operation in an engine lubrication system to deliver lubricant to engine components. As a result, the likelihood of component degradation, damage, malfunction, etc., caused by improper lubrication is reduced.

In one example, the method includes determining a duration and speed of crankshaft rotation needed to induce lubricant delivery to one or more lubricated components in the engine based on ambient temperature. For instance, the duration and/or speed of the intended crankshaft rotation may be increased when the ambient temperature is below a threshold value. On the other hand, the duration and/or speed of the intended crankshaft rotation may be decreased when the ambient temperature is above a threshold value. After, the duration and speed of the crankshaft rotation to induce engine lubrication operation is ascertained, the crankshaft may be rotated via operation of an electric machine at the determined speed and for the determined duration. By taking into account ambient conditions the efficiency of engine lubrication operation during combustion inactivity is increased while providing a desired amount of component lubrication, thereby decreasing power loss in an electrical storage device caused by operation of the electric machine to crank the engine. The method's entry conditions may include a condition when a period of combustion inactivity exceeds a threshold duration, a condition when a state of charge of an electrical storage device is above a limit and attached to an external power source, and/or a condition when the vehicle is stationary. In this way, crankshaft rotation operation for inducing engine lubrication may be implemented when combustion inactivity necessitates engine lubrication operation and in a manner that does not interfere with hybrid vehicle battery charging. Consequently, the likelihood engine component wear, degradation, malfunction, failure, etc., caused by a lack of lubrication is reduced, thereby increasing not only the engine's reliability but also its longevity.

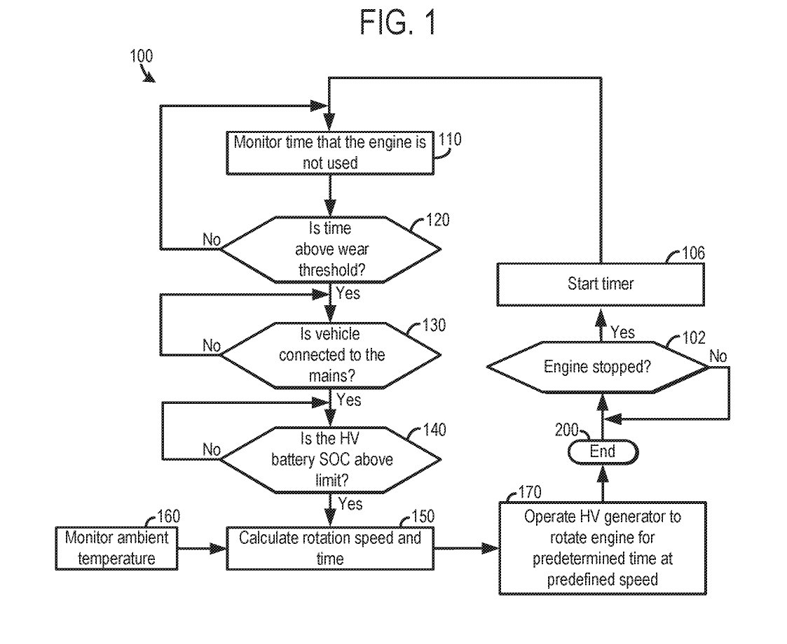

With particular reference to FIG. 1 there is shown in the form of a high level flow chart a method 100 of controlling the operation of a range extended plug-in hybrid vehicle having a combustion engine driving a high voltage electrical machine (a motor-generator) in order to reduce or eliminate excessive wear of a combustion engine of the vehicle.

The method advances from box 110 to box 120 where the accumulated time since the combustion engine was last run is compared with a predefined time threshold referred to as a ‘wear threshold’. The wear threshold is a length of time after which excessive wear of moving parts of the combustion engine will occur when it is next run due to oil draining from parts of the combustion engine. The draining of the oil has two effects, firstly it allows corrosion of the parts to occur more rapidly and secondly because there is substantially no oil film present between contacting surfaces, a high level of abrasive wear will occur during an initial period following start-up until an oil film is re-established. The value chosen for the wear threshold is based upon experimental data and is a compromise between no increased wear and corrosion which will result in the combustion engine being operated more frequently and unacceptable wear and corrosion that will significantly reduce the service life of the combustion engine and/or increase the probability of unreliable operation of the combustion engine. It will be appreciated that the wear threshold need not be a fixed value but can be adjusted based upon vehicle operating conditions.

For example, when the ambient temperature is low it could be longer than in when the ambient temperature is high to take into account of variations in oil viscosity due to temperature that will effect draining of the oil.

If the length of time that the combustion engine has not been run exceeds the wear threshold when checked in box 120, the method advances to box 130 otherwise it returns to box 110 and will continue to cycle around boxes 110 and 120 until the wear threshold is exceeded. It will be appreciated that, although not shown in FIG. 1, if the combustion engine is started in order to provide additional electric power to the vehicle or for any other reason than the timer or other timing device will be re-zeroed when the period of running ends that is to say the method will return to box 102.

In box 130 it is checked whether the vehicle is connected to a mains supply of electricity. It will be appreciated that plug-in electric vehicles have an on-board electrical storage device (e.g., high voltage battery) that is used to power an electric motor which propels the vehicle and that this battery is recharged (e.g., primarily recharged) by connecting it to a mains supply of electricity via a cable or in some cases by a contactless coupling often referred to as an ‘inductive coupling’.

The test is box 130 checks whether such a connection is present and if it is the method advances to box 140 and if no such connection is present the method returns to repeat box 130. In box 140 it is checked whether the state of charge (SOC) of the electrical storage device (e.g., high voltage battery) is above a predefined limit. The test in box 140 checks whether the electrical storage device (e.g., high voltage battery) is above a threshold SOC (e.g., fully charged) before allowing the method to advance to box 150. This is because priority is given to charging the electrical storage device (e.g., high voltage battery) as it is this source of electrical energy that is used by the electric motor to propel the vehicle.

Therefore, if the SOC of the electrical storage device (e.g., high voltage battery) is not above the predefined charging limit the method will cycle around box 140 until the SOC of the electrical storage device reaches the required level.

When the SOC of the high voltage battery reaches the required level the method advances to box 150 where a run time and run speed is calculated for the combustion engine.

The run time and run speed is a combination required to ensure that the various components of the combustion engine that need to be supplied with oil receive such a supply. It will be appreciated that in the case of an engine driven oil pump there is a delay between initial running of the oil pump and the generation of sufficient pressure to lubricate the various components of the combustion engine. As indicated by the input from box 160 to box 150 the combination of run time and run speed is related to ambient temperature because the viscosity of the oil will vary based upon temperature and, because the combustion engine has not been running, the temperature of the oil will be substantially equal to ambient temperature.

From box 150 the method advances to box 170 where electric power is supplied from the high voltage battery to the motor-generator and the motor-generator is used to rotate the combustion engine at the required run speed for the required run time. It will be appreciated that this will result in the motor-generator rotating a crankshaft of the combustion engine which drives the lubrication oil pump thereby producing a flow of oil through the combustion engine to the various components requiring a supply of oil.

It will be appreciated that during this process the combustion engine is not running that is to say no fuel is provided to the engine and combustion is not taking place. In some embodiments the timing and/or actuation of any intake and exhaust valves is also controlled in order to reduce the torque required to rotate the crankshaft of the combustion engine.

When the combustion engine has been rotated for the desired run time at the desired run speed, the motor-generator is switched off and one cycle of the method 100 ends as indicated in box 200. However, it will appreciated that in practice the method will return from box 200 to box 102 and any timer or time measuring device will then be re-zeroed as before in box 106.

Therefore in one embodiment, the method comprises measuring a length of time during which the combustion engine has not been run and, when the length of time exceeds a predefined time threshold and two vehicle operating parameters have been met, a crankshaft of the combustion engine is rotated so as to supply oil from the oil pump to various components of the combustion engine.

The two vehicle operating parameters being in the case of this preferred embodiment, a state of charge of the high voltage electrical storage device being above a predefined limit and a confirmation that the vehicle is connected to an external mains supply of electricity.

It will however be appreciated that other vehicle parameters could be used, for example and without limitation, the combustion engine could be rotated while the vehicle is stationary provided the state of charge of the high voltage battery is above a predefined level even if the vehicle is not connected to a mains supply of electricity.

Another possible arrangement is that the combustion engine could be rotated while the vehicle is in motion if either the state of charge of the high voltage battery is above a predefined level or while the vehicle is recuperating electrical energy and the rate at which electrical energy is being recuperated is sufficient to balance any drain on the high voltage battery.

It will also be appreciated that as yet another alternative embodiment, a separate electric motor driveably connected to the crankshaft of the combustion engine and connected to an additional battery could be used to rotate the combustion engine so that there is no direct drain from the high voltage battery.

It will be appreciated that the method described herein and as shown in FIG. 1 is exemplary in nature and shows only the primary control steps. For example, if the driver charges the vehicle regularly but stops charging before the high voltage battery pack is above a predefined level then the combustion engine will be automatically started in order to top up the high voltage battery pack thereby ensuring reliability of use.

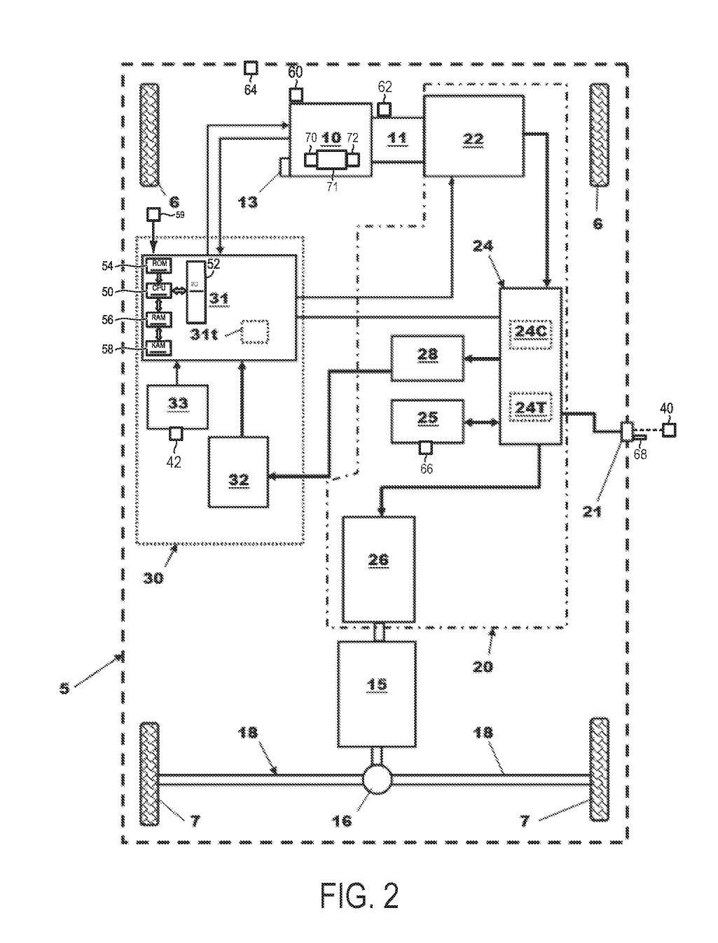

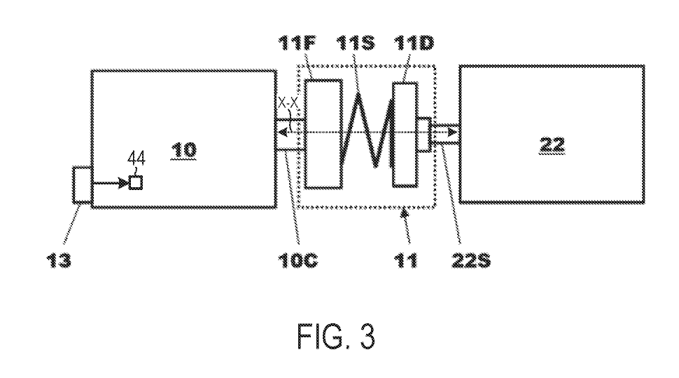

With particular reference to FIGS. 2 and 3 there is shown a hybrid vehicle 5 (e.g., range extended plug-in hybrid electric vehicle) having a combustion engine 10 such as a gasoline or diesel internal combustion engine driveably connected to a high voltage electrical machine in the form of a motor-generator 22 via a coupling 11, an engine driven lubrication oil pump 13, a drivetrain including a transmission 15 driving a pair of rear road wheels 7 via a driveline comprised of a differential 16 and rear drive shafts 18, a pair of front wheels 6, a high voltage electrical system 20 and a low voltage electrical system 30. It will be appreciated that in other embodiments the transmission 15 could be arranged to drive only the front road wheels 6 or all of the road wheels 6, 7. The transmission 15 can be of any suitable type able to provide one or more drive ratios between the high voltage electric traction motor 26 and the rear wheels 7. It will be appreciated that in other examples, the motor-generator 22 may be more generally an electric machine.

With particular reference to FIG. 3 the coupling 11 comprises a flywheel 11F of predefined inertia fastened to one end of a crankshaft 10C of the reciprocating piston engine 10, a drive plate 11D of lower inertia than the flywheel 11F driveably connected to an input shaft 22S of the motor-generator 22 and a resilient rotary drive 115 driveably connecting the flywheel 11F to the drive plate 11D. The resilient rotary drive 115 may for example comprise a number of compression springs interposed between respective abutments on the flywheel 11F and the drive plate 11D. The compression springs are tangentially arranged with respect to a circle centered on a longitudinal axis of rotation X-X extending between the crankshaft 10C and the input shaft 22S of the motor-generator 22. Such a resilient rotary drive arrangement is often used in friction clutch driven plates and in dual mass flywheels and so will not be described in detail here.

It will be appreciated that although in this embodiment the motor-generator 22 is driven directly by the crankshaft 10C via a coupling 11, the vehicle configuration is not limited to such a drive and the motor-generator could be driveably connected to the crankshaft 10C of the engine by other drive means such as, for example, a belt drive, a chain drive or a gear drive.

The high voltage electrical system 20 includes the motor-generator 22 driveably connected via the coupling 11 to the engine 10, a high voltage power distribution module 24, an electrical storage device 25 (e.g., high voltage electrical storage device) which in this case is in the form of a high voltage battery pack (e.g., forty eight volt battery pack) used to store electrical energy that is input from an external mains supply 40 to which it is selectively connectable via a mains connector 21, a high voltage electric traction motor 26 electrically connectable to the electrical storage device 25 and arranged to selectively drive the transmission 15 and, in the case of this example, an AC to DC converter 28 to supply electrical energy to the low voltage battery 32 to recharge it. However, numerous electrical storage device configurations have been contemplated.

The external mains supply 40 may be an electrical grid and the mains connector 21 may be a suitable electrical interface such as a domestic socket, plugs specifically designed for hybrid vehicle charging such as type 1 plugs, type 2 plugs, combination plugs (e.g., combined charging system plug), etc.

The low voltage electrical system 30 includes a low voltage electrical storage device in the form of a battery 32 (e.g., twelve volt battery), an electronic controller 31 and a driver demand input device in the form of a position sensor 33 connected to an accelerator pedal 42 to provide a signal to the electronic controller 31 indicative of driver demand.

The high voltage power distribution module 24 comprises in the case of this example, a control module 24C to control the flow of high voltage electrical power in the high voltage electrical system 20 between the various components forming the high voltage electrical system 20 and an AC to DC converter 24T to convert mains alternating current into the high voltage direct current that is stored in the high voltage battery 25. It will be appreciated that in some alternative embodiments the function of the AC to DC converter 24T may be performed by an external unit so that the mains connector 21 when connected to a mains supply receives a direct current supply of the correct voltage for storage in the high voltage battery 25. The control module 24C of the high voltage power distribution module 24 is operatively connected to and controlled by the electronic controller 31 of the low voltage electrical system 30.

It will be appreciated that the mains connector 21 could be in the form of a plug and socket arrangement or could be in the form of a contactless connection such as an inductive coupling, for example.

The electronic controller 31 could be formed from a number of connected electronic units but in the case of this example and as shown in FIGS. 1 and 2 is a single unit arranged to control the operation of the engine 10, the high voltage electrical generator 22 and indirectly the flow of high voltage electrical power to the various components of the vehicle 5.

The electronic controller 31 is included in the vehicle 5. Specifically, the electronic controller 31 is shown in FIG. 2 as a conventional microcomputer including: microprocessor unit 50, input/output ports 52, read-only memory 54, random access memory 56, keep alive memory 58, and a conventional data bus. The electronic controller 31 is configured to receive various signals from sensors coupled to the engine 10. The sensors may include an ambient temperature sensor 59, an engine temperature sensor 60, an engine speed sensor 62, a vehicle speed sensor 64, electrical storage device state of charge sensor 66, position sensor 33, charging sensor 68, etc. Additionally, the controller 31 may be configured to trigger one or more actuators and/or send commands to components. For instance, the controller 31 may trigger adjustment of intake valve 70 in the engine 10 and coupled to a cylinder 71, exhaust valve 72 in the engine 10 and coupled to the cylinder 71, the electrical storage device 25, the engine 10, motor-generator 22, etc., via actuation of actuators in any of the controllable components. For instance, the controller 31 may send a control signal to the motor-generator 22 to include rotation of the coupling 11 (e.g., crankshaft).

Therefore, the controller 31 receives signals from the various sensors and employs the various actuators to adjust engine operation based on the received signals and instructions stored in memory (e.g., non-transitory memory) of the controller. Thus, it will be appreciated that the controller 31 may send and receive signals from engine 10, electrical systems in the vehicle 5, and other desired components.

In yet another example, the amount of component, device, actuator, etc., adjustment may be empirically determined and stored in predetermined lookup tables and/or functions. For example, one table may correspond to conditions related to motor-generator operation and one table may correspond to conditions related to engine operation.

In the case of this example a high voltage electrical machine is in the form of a motor-generator 22 that can be operated as a generator when being driven by the engine 10 or as a motor when it is driving the engine 10.

The control module 24C of the high voltage power distribution module 24 is arranged to control the flow of high voltage electrical power in a number of differing operational modes examples of which are set out briefly below.

In a first mode, when there is a requirement to drive the vehicle 5 and there is sufficient power stored in the high voltage battery 25, the control module 24C provides a supply of high voltage electrical energy from the high voltage battery 25 to the high voltage electric traction motor 26.

In a second mode, when there is a requirement to drive the vehicle 5 and there is insufficient power stored in the high voltage battery 25, the control module 24C provides a supply of high voltage electrical energy from the motor-generator 22 operating as a generator to the high voltage electric traction motor 26. There is insufficient power stored in the high voltage battery 25 when the state of charge of the high voltage battery 25 falls below a predefined level such as, for example but without limitation, 20%. Providing a supply of high voltage electrical energy from the motor-generator 22 to the high voltage electric traction motor 26 will include providing a signal to the electronic controller 31 that the engine 10 needs to be run in a power producing mode to provide electrical power from the motor-generator 22.

In a third mode, when there is a requirement to charge the high voltage battery 25, the control module 24C provides a supply of high voltage electrical energy from the mains connector 21 to the high voltage battery 25 when a connection is made to an external mains supply.

In a fourth mode, when there is a requirement to charge the low voltage battery 32, the control module 24C provides a supply of high voltage alternating current electrical energy from the motor-generator 22 to the AC to DC converter 28 to charge the low voltage battery 32.

In a fifth mode, in accordance with this description, when there is a need to rotate the crankshaft 10C of the combustion engine 10 in order to prevent excessive engine wear and corrosion, providing the motor-generator 22 with a supply of electrical power from the high voltage battery 25 and operating the motor-generator 22 as an electric motor to rotate the crankshaft 10C of the engine provided that at least one vehicle operating parameter required to permit such rotation has been met.

The electronic controller 31 includes a timer unit 31t used to measure the length of time that the combustion engine 10 remains stationary. The electronic controller 31 is arranged to use the timer 31t to measure the length of time during which the combustion engine 10 has not been run and compare the output from the timer 31t with a predefined time threshold referred to herein as a “wear threshold”. When the length of time as measured by the timer 31t exceeds the predefined time threshold the electronic controller 31 is operable to check whether other vehicle operating parameters required to permit the crankshaft 10C of the combustion engine 10 to be rotated by the motor-generator 22 acting as an electric motor so as to supply oil from the engine driven oil pump 13 to various components of the combustion engine 10 requiring a supply of oil. The effect of this action is to replenish components of the combustion engine 10 requiring a supply of oil with fresh oil thereby reducing or eliminating excessive wear of these components when the combustion engine 10 is next started to produce power.

In one example embodiment of the hybrid vehicle 5 the vehicle operating parameters required to permit the crankshaft 10C of the combustion engine 10 to be rotated by the motor-generator 22 acting as an electric motor so as to supply oil from the engine driven oil pump 13 to various components of the combustion engine 10 requiring a supply of oil are: (i) a state of charge of the high voltage battery 25 above a predefined state of charge limit and/or (ii) a confirmation that the vehicle 5 is connected via the mains connector 21 to an external mains supply of electricity. Other entry conditions for crankshaft rotation via the motor-generator include a stationary vehicle condition where it is determined that the vehicle is not moving and/or a condition when a period of combustion inactivity in the engine exceeds a threshold value. The threshold value may be calculated by taking into account the size of the engine, the lubrication requirements of lubricated components, the ambient temperature, the type of lubricant used in the engine, etc. For instance, if the lubrication requirements of the engine components is large the threshold may be decreased, in one example. On the other hand, in another example, if the lubrication requirements of the engine components is small the threshold may be increased.

However, it will be appreciated that other combinations of vehicle operating parameters required to permit the crankshaft 10C of the combustion engine 10 to be rotated by the motor-generator 22 acting as an electric motor so as to supply oil from the engine driven oil pump 13 to various components of the combustion engine 10 requiring a supply of oil are possible.

For example, a combination of a state of charge of the high voltage battery 25 above the predefined state of charge limit and a confirmation that the vehicle is stationary could be used.

It will be appreciated that in order for the engine driven oil pump 13 to generate sufficient pressure and flow it must be driven by the combustion engine 10 for a period of time and at sufficient speed to provide oil to all of the components of the combustion engine 10 requiring oil. Therefore, the electronic controller 31 may be designed to ensure that the combustion engine 10 is rotated for a period of time and at a rotational speed required to supply sufficient lubrication oil from the oil pump 13 to the components of the combustion engine 10 requiring lubricating oil. In order to do this the electronic controller 31 is arranged to receive an input of ambient temperature from an ambient air temperature sensor and calculate the period of time for which the combustion engine 10 is to be rotated and the speed that it must be rotated at based upon the measured ambient temperature. This is because both the time and the speed of rotation required are dependent upon the viscosity of the oil and this will vary with temperature. Because the combustion engine 10 will not have been working for some time (possibly several weeks) the temperature of the oil will be substantially equal to ambient air temperature.

It will be appreciated that because the motor-generator 22 is driveably connected to the crankshaft 10C of the combustion engine 10 the action of the electronic controller 31 providing a control signal to cause the motor-generator 22 to rotate the crankshaft 10C of the combustion engine 10 will directly result in the oil pump 13 being driven to supply oil to the combustion engine 10. The electrical energy required to operate the motor-generator 22 as a motor preferably comes from the external mains supply of electricity however, it will be appreciated that it could alternatively come from the high voltage battery 25.

Therefore in summary, the electronic controller is arranged to check whether the combustion engine has been stationary for longer than a predefined period of time referred to as a wear threshold and if the combustion engine has been stationary for such a long period of time is arranged to cause the combustion engine to be rotated so as to supply oil to the engine so as to reduce or prevent corrosion within the engine. However, this is only done when the performance of the vehicle will not subsequently be seriously adversely affected by a lowering of a state of charge of the high voltage battery below a level where the range of the vehicle when operating on electric power alone would be seriously reduced.

Although in the case of this example the term ‘low voltage’ has been used in respect of a voltage of twelve volts and ‘high voltage’ has been used with respect to a voltage of forty volts it will be appreciated that the electrical system in the vehicle is not limited to the use of such voltages.

FIG. 3 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

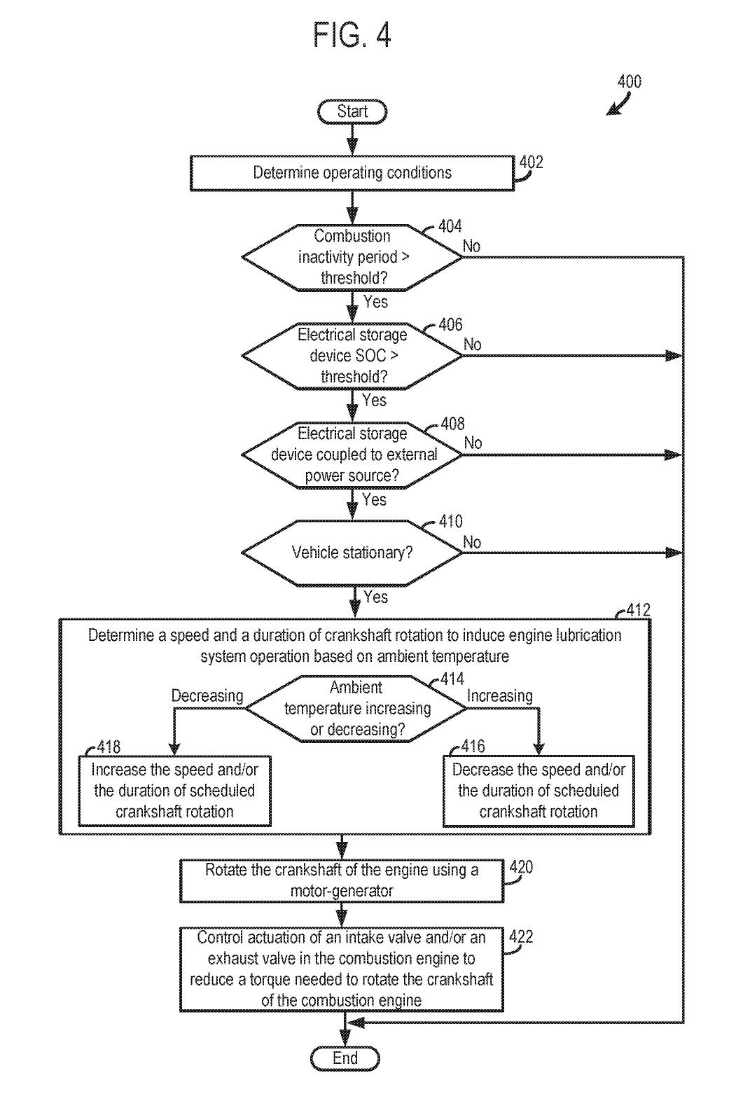

FIG. 4 shows another method 400 for operating a hybrid electric vehicle. The method 400 as well as the other methods described herein may be implemented via the hybrid electric vehicle (e.g., range extended plug-in hybrid electric vehicle) and corresponding systems and components described with regard to FIGS. 2-3.

At 402 the method includes determining hybrid vehicle operating conditions. The operating conditions may include a duration of combustion inactivity in the engine. For instance, a timer may be started when combustion operation in engine cylinders is discontinued. The operating conditions may also include ambient temperature. For instance, signals from an ambient temperature sensor may be used to determine ambient temperature. However, in other examples, the ambient temperature may be predicted from signals from other sensors. The operating conditions may also include a state of charge of the electrical storage device and a charging state of the electrical storage device. For instance, it may be ascertained if the electrical storage device is coupled to an external power source (e.g., charging station). The operating conditions may also include a vehicle speed. For instance, it may be ascertained if the vehicle is stationary from a vehicle speed sensor and/or an engine speed sensor.

At 404 it is determined if a combustion inactivity period has surpassed a threshold value. The threshold value may be 2 hours, 4 hours, 12 hours, 1 day, 2 days, 1 week, 2 weeks, etc. Furthermore, the threshold value may be determined based on the configuration of the engine lubrication system, ambient temperature, etc. In one example, the threshold value may be predetermined. However, in other examples, the threshold value may dynamically change based on engine operating conditions, ambient temperature, etc.

If it is determined that the combustion inactivity period is not greater than the threshold value (NO at 404) the method ends. On the other hand, if it is determined that the combustion inactivity period is greater than the threshold value (YES at 404) the method proceeds to 406.

At 406 the method includes determining if the electrical storage device state of charge (SOC) is greater than a threshold value. The threshold state of charge may be 10 kilowatt-hours (kWh), 20 kWh, 30 kWh, 40 kWh, 60 kWh, 70 kWh, 80 kWh, etc. However, in other examples, the state of charge may be expressed as a percentage of full capacity. For instance, the threshold state of charge may be 50%, 60%, 70%, 80%, 90%, 99%, etc. The threshold SOC may be determined by taking into account vehicle range, vehicle fuel level, etc. For instance, if the fuel level in the vehicle is low the threshold SOC may be decreased. However, if the fuel level in the vehicle is high the threshold SOC may be increased. However, other factors may be taken into account when ascertaining the SOC threshold which may include engine size, lubrication requirements of the engine, ambient temperature, etc.

If it is determined that the electrical storage device's SOC is not above the threshold value (NO at 406) the method ends. On the other hand, if it is determined that the SOC is above the threshold value (YES at 406) the method moves to 408.

At 408 the method includes determining if the electrical storage device is coupled to an external power source. For instance, such a determination may be carried out by reading sensor signals from a charging port or measuring a change in the state of charge of the electrical storage device. For instance, if the state of charge is increasing it may be ascertained that the electrical storage device is coupled to an external power source.

If it is determined that the electrical storage device is not coupled to an external power source (NO at 408) the method ends. However, if it is determined that the electrical storage device is coupled to an external power source (YES at 408) the method proceeds to 410.

At 410 the method the method includes determining if the hybrid vehicle is stationary. If it is determined that the vehicle is not stationary (NO at 410) the method ends. On the other hand, if it is determined that the vehicle is stationary (YES at 410) the method proceeds to 412.

At 412 the method includes determining a speed and duration of a scheduled crankshaft rotation needed to induce engine lubrication system operation based on ambient temperature. Step 412 may include steps 414-418.

At 414 the method includes determining if the ambient temperature is increasing or decreasing. If the ambient temperature is increasing the method moves to 416. At 416 the method includes decreasing a speed and/or duration of scheduled crankshaft rotation. On the other hand, if the ambient temperature is decreasing the method moves to 418. At 418 the method includes increasing a speed and/or duration of scheduled crankshaft.

Next at 420 the method includes rotating the crankshaft of the engine using the electric machine for the previously calculated speed and duration.

Next at 422 the method includes controlling actuation of an intake valve and/or an exhaust valve in the combustion engine to reduce a torque needed to rotate the crankshaft of the combustion engine via the electric machine. By controlling actuation of the intake and/or exhaust valves crankshaft may be more easily rotated by the electric machine, thereby increasing system efficiency. However, in other examples, step 422 may be omitted from the method. Furthermore, it will be appreciated that steps 420 and 422, in some examples, may be implemented during overlapping time periods.

The technical effect of rotating the crankshaft of the combustion engine when the aforementioned entry conditions are achieved is to increase engine lubrication during periods of combustion inactivity without adversely impacting other vehicle functions such as charging operation. Consequently, the likelihood of component wear, degradation, malfunction, etc., caused by under lubricated components is reduced, thereby increasing engine longevity and reliability. In this way, the combustion engine may achieve a desired level of lubrication in moving components even during periods (e.g., long periods) of combustion inactivity. Moreover, the crankshaft rotation may be implemented based on the state of charge of an electrical storage device to prevent interference of engine rotation operation with electrical storage device recharging. Furthermore, by taking into account ambient conditions the efficiency of the engine lubrication process may be increased.

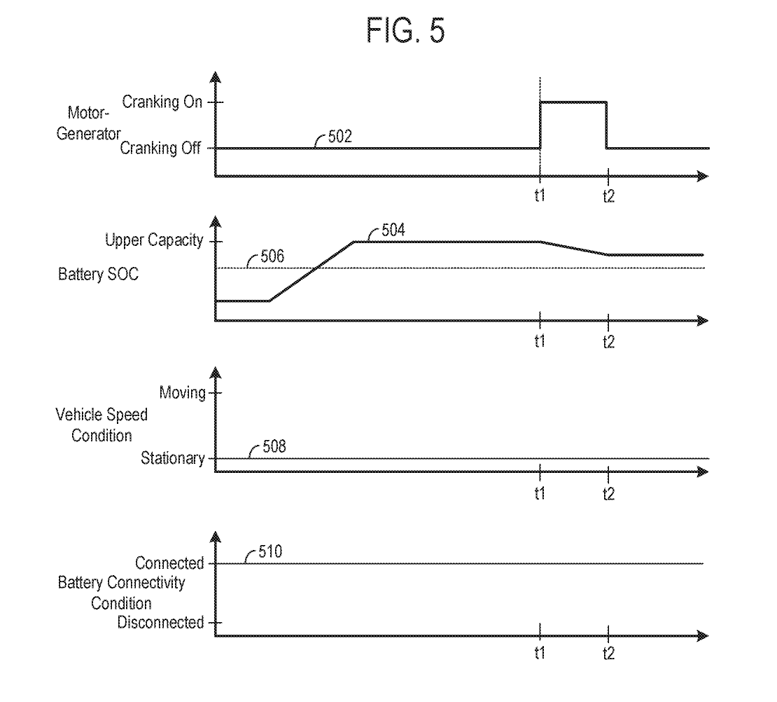

Now turning to FIG. 5, depicting examples of control signal graphs and hybrid vehicle conditions occurring during implementation of a control strategy for the hybrid vehicle described above with regard to FIGS. 1-4. The example of FIG. 5 is drawn substantially to scale, even though each and every point is not labeled with numerical values. As such, relative differences in timings can be estimated by the drawing dimensions. However, other relative timings may be used, if desired. Furthermore, in each of the graphs time is represented on the abscissa. Additionally, the graphical control strategy of FIG. 5 is illustrated as a use case example and that numerous hybrid vehicle control strategies have been contemplated.

A motor-generator condition, is indicated at 502 with a “cranking on” state and a “cranking off” state provided on the ordinate. In the “cranking on” state the motor-generator functions to rotate the crankshaft in the engine to induce lubrication pumping in the lubricant system in the engine to lubricate desired components. In the “cranking off” state the motor-generator is configured such that it does not rotate the engine crankshaft. It will be appreciated that the motor-generator may be operated in “the cranking on” state while fuel and/or spark delivery to the engine's cylinders is inhibited, in one example. On the abscissa, t1 indicates a threshold period of time of engine inactivity. The threshold time period may be calculated based on engine lubrication needs, engine size, battery SOC, etc., as previously discussed.

A battery SOC is also shown at 504. The battery's upper SOC is indicated on the ordinate. A threshold battery SOC is indicated at 506. The threshold battery SOC may correspond to a threshold value that acts as an entry condition for cranking the engine via the motor-generator to drive engine lubrication. The threshold SOC may be ascertained based on vehicle range, engine lubrication needs, etc., as previously discussed.

A vehicle speed condition is given at 508. A moving and stationary condition are indicated on the ordinate. Additionally, a battery connectivity condition is indicated at 510. A connected condition indicating that the battery is connected to an external power source is provided on the ordinate. A disconnected condition indicating that the battery is not connected to an external power source is also provided on the ordinate.

As shown, when the time threshold t1 is surpassed, the battery SOC is above the threshold 506, and the vehicle is stationary and connected to an external power source the motor-generator is turned on to induce lubricant pumping in the engine. In this way, the engine may be cranked during periods of inactivity to reduce the likelihood of wear caused by improperly lubricated components. However, other combinations of entry conditions for motor-generator operation that trigger lubrication operation have been contemplated, as previously discussed. It will be appreciated that the duration of motor-generator operation (i.e., t2−t1) may be selected based on ambient temperature conditions. For instance, if the ambient temperature is increasing the duration of motor-generator operation may be decreased and if the ambient temperature is decreasing the duration of motor-generator operation may be increased. Additionally, the speed of motor-generator rotation may also be adjusted in a similar fashion based on the ambient temperature.

The invention will be further described in the following paragraphs. In one aspect, a method of controlling the operation of a range extended plug-in hybrid electric vehicle having a combustion engine driving an engine lubrication oil pump, an electrical machine driveably connected to a crankshaft of the combustion engine, a high voltage electrical storage device to store electrical energy and a high voltage electric traction motor electrically connected to the high voltage electrical storage device and arranged to selectively drive the range extended plug-in hybrid electric vehicle is provided. The method includes measuring a length of time during which the combustion engine has not been run, and when the length of time exceeds a predefined time threshold and a state of charge of the high voltage electrical storage device is above a predefined limit and the range extended plug-in hybrid electric vehicle is connected to an external mains supply of electricity and the range extended plug-in hybrid electric vehicle is stationary, using the electrical machine to rotate the crankshaft of the combustion engine so as to supply oil from the engine lubrication oil pump to components of the combustion engine, where the combustion engine is rotated for a period of time and at a rotational speed sufficient to supply lubrication oil to oil lubricated components of the combustion engine, the period of time for which the combustion engine is to be rotated and the rotational speed of the combustion engine when it is rotated are both calculated based upon an ambient temperature.

In another aspect, a range extended plug-in hybrid electric vehicle having a combustion engine driving an engine lubrication oil pump, an electrical machine driveably connected to a crankshaft of the combustion engine, a high voltage electrical storage device to store electrical energy, a high voltage electric traction motor electrically connected to the high voltage storage device and arranged to selectively drive the electric vehicle and an electronic controller, the electronic controller includes instructions stored in memory that when executed by a processor cause the range extended plug-in hybrid electric vehicle to measure a length of time during which the combustion engine has not been run and, when the length of time exceeds a predefined time threshold and a state of charge of the high voltage electrical storage device is above a predefined limit and the vehicle is connected to an external mains supply of electricity and the vehicle is stationary, is further operable to use the electrical machine to rotate the crankshaft of the combustion engine so as to supply oil from the oil pump to components of the combustion engine where the combustion engine is rotated for a period of time and at a rotational speed sufficient to supply lubrication oil to oil lubricated components of the combustion engine, the period of time for which the engine is to be rotated and the rotational speed of the engine when it is rotated are both calculated based upon ambient temperature.

In yet another aspect, a method is provided that comprises determining a duration and a speed of crankshaft rotation inducing lubricant delivery to a lubricated component in an internal combustion engine of a vehicle based on an ambient temperature and when a combustion inactivity period exceeds a threshold and a state of charge of an electrical storage device is above a limit and attached to an external power source, rotating the crankshaft for the duration and speed using an electric machine.

In another aspect, a method of controlling the operation of a range extended plug-in hybrid electric vehicle having a combustion engine driving an engine lubrication oil pump, an electrical machine driveably connected to a crankshaft of the combustion engine, a high voltage electrical storage device to store electrical energy and a high voltage electric traction motor electrically connected to the high voltage electrical storage device and arranged to selectively drive the range extended plug-in hybrid electric vehicle is provided. The method includes measuring a length of time during which the combustion engine has not been run, determining if the range extended plug-in hybrid electric vehicle is attached to an external power source, determining a period of time and speed of crankshaft rotation that is sufficient to supply lubrication oil to one or more lubrication components based on an ambient temperature, and when the length of time exceeds a predefined time threshold, a state of charge of the high voltage electrical storage device is above a predefined limit, the range extended plug-in hybrid electric vehicle is attached to the external power source, and the range extended plug-in hybrid electric vehicle is stationary using the electrical machine to rotate the crankshaft of the combustion engine so as to supply oil from the engine lubrication oil pump to a lubricated component in the combustion engine.

In any of the aspects or combinations of the aspects, the electrical machine may be a motor-generator driveably connected to the crankshaft of the combustion engine and rotating the crankshaft of the combustion engine may comprise providing a control signal from the electronic controller to cause the motor-generator to rotate the crankshaft of the combustion engine.

In any of the aspects or combinations of the aspects, electrical energy from the high voltage storage device may be used to power the motor-generator.

In any of the aspects or combinations of the aspects, electrical energy from an external mains supply of electricity may be used to power the motor-generator.

In any of the aspects or combinations of the aspects, the method may further comprise determining if the ambient temperature is increasing or decreasing.

In any of the aspects or combinations of the aspects, the method may further comprise when it is determined that the ambient temperature is increasing, decreasing the period of time the internal combustion engine is rotated and/or decreasing the rotational speed of the combustion engine.

In any of the aspects or combinations of the aspects, the method may further comprise when it is determined that the ambient temperature is decreasing, increasing the period of time the internal combustion engine is rotated and/or decreasing the rotational speed of the combustion engine.

In any of the aspects or combinations of the aspects, the method may further comprise controlling actuation of an intake valve and/or an exhaust valve in the internal combustion engine to reduce a torque needed to rotate the crankshaft of the internal combustion engine for the duration and speed.

In any of the aspects or combinations of the aspects, controlling actuation of the intake valve and/or the exhaust valve may include opening at least one of the intake and/or exhaust valve when the electric machine rotates the crankshaft.

It will be appreciated by those skilled in the art that although the invention has been described by way of example with reference to one or more embodiments it is not limited to the disclosed embodiments and that alternative embodiments could be constructed without departing from the scope of the invention as defined by the appended claims.

It will be also appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method of controlling the operation of a range extended plug-in hybrid electric vehicle having a combustion engine driving an engine lubrication oil pump, an electrical machine driveably connected to a crankshaft of the combustion engine, a high voltage electrical storage device storing electrical energy and a high voltage electric traction motor electrically connected to the high voltage electrical storage device and arranged to selectively drive the range extended plug-in hybrid electric vehicle, the method comprising:
measuring a length of time during which the combustion engine has not been run; and
when the length of time exceeds a predefined time threshold and a state of charge of the high voltage electrical storage device is above a predefined limit and the range extended plug-in hybrid electric vehicle is connected to an external mains supply of electricity and the range extended plug-in hybrid electric vehicle is stationary, using the electrical machine to rotate the crankshaft of the combustion engine so as to supply oil from the engine lubrication oil pump to components of the combustion engine;
where the combustion engine is rotated for a period of time and at a rotational speed sufficient to supply lubrication oil to oil lubricated components of the combustion engine, the period of time for which the combustion engine is to be rotated and the rotational speed of the combustion engine when it is rotated are both calculated based upon an ambient temperature.

2. The method of claim 1, where the electrical machine is a motor-generator driveably connected to the crankshaft of the combustion engine and rotating the crankshaft of the combustion engine comprises using the motor-generator to rotate the crankshaft of the combustion engine.

3. The method of claim 2, where electrical energy from the high voltage electrical storage device is used to power the motor-generator.

4. The method of claim 2, where electrical energy from the external mains supply of electricity is used to power the motor-generator.

5. The method of claim 1, further comprising determining if the ambient temperature is increasing or decreasing.

6. The method of claim 5, further comprising, when it is determined that the ambient temperature is increasing, decreasing the period of time the combustion engine is rotated and/or decreasing the rotational speed of the combustion engine when is it rotated.

7. The method of claim 6, further comprising, when it is determined that the ambient temperature is decreasing, increasing the period of time the combustion engine is rotated and/or decreasing the rotational speed of the combustion engine when is it rotated.

8. The method of claim 1, further comprising controlling actuation of an intake valve and/or an exhaust valve in the combustion engine to reduce a torque needed to rotate the crankshaft of the combustion engine.

9. A range extended plug-in hybrid electric vehicle comprising:
a combustion engine driving an engine lubrication oil pump;
an electrical machine driveably connected to a crankshaft of the combustion engine;
a high voltage electrical storage device to store electrical energy;
a high voltage electric traction motor electrically connected to the high voltage electrical storage device and arranged to selectively drive the range extended plug-in hybrid electric vehicle; and
an electronic controller, the electronic controller includes instructions stored in memory that when executed by a processor cause the range extended plug-in hybrid electric vehicle to:
measure a length of time during which the combustion engine has not been run; and
when the length of time exceeds a predefined time threshold, a state of charge of the high voltage electrical storage device is above a predefined limit, the range extended plug-in hybrid electric vehicle is connected to an external mains supply of electricity, and the range extended plug-in hybrid electric vehicle is stationary, use the electrical machine to rotate the crankshaft of the combustion engine so as to supply oil from the engine lubrication oil pump to components of the combustion engine;
where the combustion engine is rotated for a period of time and at a rotational speed sufficient to supply lubrication oil to one or more oil lubricated components of the combustion engine; and
where the period of time for which the combustion engine is to be rotated and the rotational speed of the combustion engine when it is rotated are both calculated based upon an ambient temperature.

10. The range extended plug-in hybrid electric vehicle of claim 9, where the electrical machine is a motor-generator driveably connected to the crankshaft of the combustion engine and rotating the crankshaft of the combustion engine comprises providing a control signal from the electronic controller to cause the motor-generator to rotate the crankshaft of the combustion engine.

11. The range extended plug-in hybrid electric vehicle of claim 10, where electrical energy from the high voltage electrical storage device is used to power the motor-generator.

12. The range extended plug-in hybrid electric vehicle of claim 10, where electrical energy from the external mains supply of electricity is used to power the motor-generator.

13. The range extended plug-in hybrid electric vehicle of claim 9, where the electronic controller further includes instructions stored in memory that when executed by the processor cause the range extended plug-in hybrid electric vehicle to;
determine if the ambient temperature is increasing or decreasing;
when it is determined that the ambient temperature is increasing, decrease the period of time the combustion engine is rotated and/or decreasing the rotational speed of the combustion engine when is it rotated; and
when it is determined that the ambient temperature is decreasing, increase the period of time the combustion engine is rotated and/or decreasing the rotational speed of the combustion engine when is it rotated.

14. The range extended plug-in hybrid vehicle of claim 9, where the electronic controller further includes instructions stored in memory that when executed by the processor cause the range extended plug-in hybrid electric vehicle to;
control actuation of an intake valve and/or an exhaust valve in the combustion engine to reduce a torque needed to rotate the crankshaft of the combustion engine.

15. A method comprising:
determining a duration and a speed of crankshaft rotation inducing lubricant delivery to a lubricated component in an internal combustion engine of a vehicle based on an ambient temperature; and
when a combustion inactivity period exceeds a threshold and a state of charge of an electrical storage device is above a limit and attached to an external power source, rotating the crankshaft for the duration and speed using an electric machine.

16. The method of claim 15, further comprising determining if the ambient temperature is increasing or decreasing.

17. The method of claim 16, further comprising, when it is determined that the ambient temperature is increasing, decreasing the period of time the internal combustion engine is rotated and/or decreasing the rotational speed of the internal combustion engine.

18. The method of claim 16, further comprising, when it is determined that the ambient temperature is decreasing, increasing the period of time the internal combustion engine is rotated and/or decreasing the rotational speed of the internal combustion engine.

19. The method of claim 15, further comprising controlling actuation of an intake valve and/or an exhaust valve in the internal combustion engine to reduce a torque needed to rotate the crankshaft of the internal combustion engine for the duration and speed.

20. The method of claim 19, where controlling actuation of the intake valve and/or the exhaust valve includes opening at least one of the intake and/or exhaust valve when the electric machine rotates the crankshaft.
